(19) United States
(12) Patent Application Publication
(10) Pub. No.: US 2015/0050977 A1
(43) Pub. Date: Feb. 19, 2015

(54) SECURITY METHODS USING MOBILE DEVICES

(71) Applicant: Omarco Network Solutions Limited, Douglas, Isle of Man (GB)

(72) Inventor: Ralph Mahmoud Omar, Douglas, Isle of Man (GB)

(73) Assignee: Omarco Network Solutions Limited, Douglas, Isle of Man (GB)

(21) Appl. No.: 14/388,476

(22) PCT Filed: Mar. 27, 2013
(86) PCT No.: PCT/GB2013/050808

§ 371 Date: Sep. 26, 2014

(30) Foreign Application Priority Data
Mar. 27, 2012 (GB) 1205401.1

(51) Int. Cl. G07F 17/32; H04W 12/08; H04W 12/06; H04L 29/06; H04M 1/725

(52) U.S. Cl. CPC G07F 17/3241; H04L 63/10; H04M 1/72577; H04W 12/06; H04W 12/08; H04M 1/72544; G07F 17/329
USPC 463/17; 455/26.1; 455/411

(57) ABSTRACT

A system for creating a virtual ticket from a fixed location using a portable user device as a ticketing terminal, the virtual ticket having a plurality of user-selected variables associated with the virtual ticket, the system comprising: a local device arranged to broadcast an identifying signal at the fixed location in a vicinity of the local device; the portable user device having a wireless communications module, the portable user device comprising: a receiver for receiving the identifying signal when in the vicinity of the local device at the fixed location, the portable user device being arranged to display ticketing information relating to the identifying signal on the portable user device, the ticketing information including at least some of the user-selectable variables; a user selection module arranged to enable the user to select the values of the plurality of the user-selectable variables relating to the displayed ticketing information; wherein the wireless communications module is arranged to transmit a ticketing request message including the plurality of user-selected variables to a remote server and to receive a unique identifier from the server which enables the creation of the virtual ticket on the portable user device.

### FIELD OF INVENTION

The present invention relates to the security methods for use with portable/mobile devices such as smart phones, tablet computers or laptops where all such devices have a telecommunications function or ability (with all such devices described above are hereinafter known in this patent application as “Personal Communications Device” or “PCD”). More particularly, though not exclusively, it relates to the ability to use the PCD for purchasing a virtual ticket for use in a prize incentive draw and a short/medium or long term financial instrument and/or investment.

### BACKGROUND OF INVENTION

When selling a financial instrument or investment or conducting a financial transaction using any form of electronic terminal, it is a requirement that the user has to prove their identity. With a manned electronic terminal the user can be asked for ID such as a passport or driver's licence as proof of identity. However, when using an unmanned terminal dealing with this requirement this is more challenging. Still, it is possible to scan an electronically readable identity document, such as an electronically-readable passport and to use this as proof of identity which can address at least partially this issue.

However, when using a general-purpose personal device such as a laptop, smart phone or PCD which can be configured to act as a ticket issuing terminal to issue a virtual ticket for example, there are still problems. This is because typically such personal devices do not have scanning facilities mentioned above in order to read electronically readable identity documents. Even for devices that do (such as a specialised PCD or mobile phones with imaging devices e.g. a camera), there is no way to provide a human interface that assures that the ID is that of the actual person entitled to the transaction. Also, it would still be difficult to access live databases which enable valid comparisons of that personal identification information which has been electronically read from the document. Furthermore, such devices with a scanning capability would struggle to try to implement any such system mimicking a verification terminal in real time.

Users of most mobile devices are registered with a central service provider. These users operate a so called ‘post-pay service’ where they are billed on a monthly cycle. Their account details can be stored centrally and be used to provide some of the information required for registering for a financial bond. However, there are often restrictions about releasing this information to third parties who may require this information for providing a service to the user such as a financial service for example. Also even when such information is available this does not solve the problem of verifying that the actual user of the device is the same as the registered user, which would be required to prevent fraud. Whilst it is possible for the service provided to supply a PIN or password to be used when accessing their services, such security provisions only apply when accessing a gateway to the mobile service provider's service. Devices can also come with their own PIN or password for use, but again these often only apply for initial access, such that once an initial security screen has been passed through, no further checks are carried out as all actions are assumed to be with valid user risking that a further transaction is undertaken by an unauthorised or fraudulent user. In addition, cloned devices may still appear authorised and mimic the primary authentication hence there is a need for continuing authentication as and when the PCD is used.

Ideally, a more secure way of using a PCD is required which does not inconvenience the user as much but retains a high level of security.

Many other users operate a so called ‘pay-as-you-go’ account and may wish to operate this anonymously. For these users there is a real problem in proving their identity using a PCD or simple mobile device as they only have a basic account which provides no information on their home address or bank details for example. None of this information can be used to verify the identity of the valid user.

US 2009/328202 discloses that it is known to password-protect certain functions of a mobile device, e.g. camera function, email function, and in particular communication functions. This arrangement retains the drawback that a user must enter a password each time they wish to send any communication. Furthermore, security may be compromised if the user is observed when entering the password.

Lottery systems are typically paper-based and this can cause a problem in that users tend to lose tickets. This is a problem with a lottery but also a particular problem when the paper ticket has a dual purpose beyond the life of the lottery or prize draw to which is directed, namely it is to have a longer term function. In particular, with a two-stage multifunction ticket, as is described in our international patent application published as WO2009/019602A, there is a tendency to lose tickets once they have been unsuccessful in the prize draw which means they are not re-registered for the second stage long-term investment product. Also there is a lengthy and awkward data entry procedure entering in all of the unique identifiers of those tickets when re-registering for the second stage.

The present invention aims to provide a solution to at least some of the above described problems.

### SUMMARY OF INVENTION

According to one aspect of the present invention there is provided a security device for a portable telecommunications device for controlling each communication from the device to a particular telecommunications address, the security device comprising: a data store for storing a personal identifier of at least four alphanumeric characters initially input into the security device by the user during a set-up procedure; control means for controlling access to a communications module of the telecommunications device; presenting means for presenting, on the portable telecommunications device, a variable identifier identifying a predetermined variable associated with the personal identifier for input of a portion of the personal identifier; enabling means for enabling a user to input a portion of the personal identifier determined by the value of the predetermined variable; and comparing means for comparing the input portion with the corresponding portion of the stored personal identifier; wherein the control means is arranged to enable access to the communications module of the telecommunications device for sending a communication to the particular telecommunications address, if the comparing means show the input portion matches the corresponding portion of the stored personal identifier.

One of the key advantages of the present invention is that it enables a higher level of security that has been provided by passwords or keylocks as it can be used on every use of the mobile device to make a communication. However, preferably the portion of the personal identifier is a maximum of three digits and so the burden of having to input lengthy passwords or long unique identifiers each time, which is practically unworkable, is avoided and makes the present invention practically implementable. The personal identifier is preferably a birth date or name which is enough information to provide security but not enough to cause a user who still wishes to remain anonymous to be unduly concerned.

Preferably the telecommunications address is one selected from the group comprising an SMS short code, an Internet Protocol address, an email address, an IMSI address and a telephone number.

The predetermined variable may relate to the position of the personal identifier in relation to the telecommunications address which is to be entered.

The portion of the personal identifier may comprise no more than three characters.

The predetermined variable may relate to the number of characters of the personal identifier which are to be entered. Alternatively, or in addition, the predetermined variable may relate to the content of the personal identifier which is to be entered.

In an embodiment, the device is further arranged to randomly generate the value of the predetermined variable.

The presenting means may be arranged to present a graphical representation of the unique identifier to the user on the portable telecommunications device.

The device may comprise a downloadable application arranged to provide the control means, the presenting means, the enabling means and the comparing means.

The present invention extends to a system comprising a security device provided on a portable telecommunications device as described above and a remote server for authenticating the user, the remote server comprising: a data store for storing a personal identifier; comparing means for comparing a received message containing the user-entered portion of the personal identifier with the stored personal identifier; validation means for validating the user associated with the received message as authentic if the comparing means determines that the user entered portion of the personal identifier corresponds to the stored personal identifier; and sending means for sending a validation message to the source of the received message, if the validation means determines a positive validation of the sender of the received message.

According to another aspect of the present invention, there is provided a method of verifying the identity of the user of a telecommunications device prior to sending a telecommunications message from the device to a particular telecommunications address, the method comprising: presenting, on the portable telecommunications device, a value of a predetermined variable associated with a stored personal identifier; enabling a user to input a portion of the personal identifier, wherein the personal identifier portion is entered in accordance with the value of the predetermined variable presented to the user; comparing the personal identifier portion with the stored personal identifier; and enabling access to a communications module of the telecommunications device for sending the telecommunications message, if the comparing means show the personal identifier portion corresponds to the stored personal identifier.

According to another aspect of the invention there is provided a security method for verifying the identity of the user of a portable telecommunications device, the method comprising: presenting, on the portable telecommunications device, a value of a predetermined variable associated with data entry of a telecommunications address; receiving a composite data string which comprises the telecommunications address and a portion of a personal identifier of the user, wherein the personal identifier portion is entered in accordance with the value of the predetermined variable presented to the user; extracting the personal identifier portion from the composite data string using the value of the predetermined variable and placing the personal identifier portion in a body of a telecommunications message or data stream; extracting the telecommunications address from the composite data string and placing this in an address field of the telecommunications message or data stream; sending the message to the telecommunications address specified in the message; and receiving an authentication message from a remote server authenticating the user if the portion of the personal user identifier sent is a valid portion of the personal identifier stored at a remote location.

In an embodiment where the telecommunications addresses are internet addresses, the first step would be for the user to log on to his suppliers' Internet website and verify his identity in the ordinary way. Following this, he would be given an add-on identifier of his choice whether this is in numeral or alphabetical form such that for subsequent accesses he would logon with the suppliers' ordinary Internet address to which would be added his self-selected add-on identifier which would be totally personal to the user.

Preferably the telecommunications address is one selected from the group comprising an SMS short code, an Internet Protocol address, an email address, an IMSI address and a telephone number.

Advantageously the personal identifier may comprise at least four bits and the portion of the personal identifier may comprise no more than three bits. This is an optimum arrangement of bits to ensure that the security scheme is workable in practice whilst still giving an appropriate level of security.

The predetermined variable may in one embodiment relate to the amount of the personal identifier which is to be entered, namely the size of the portion. In another embodiment, it may relate to the location at which the portion of the personal identifier should be entered in relation to the communications address. In a further embodiment the predetermined variable may relate to the content of the personal identifier which is to be entered. It is also possible to combine these different requirements for the predetermined variable.

The method may further comprise randomly generating the value of the predetermined variable.

Preferably the sending step further comprises sending the identity of the PCD in the message. Thus the security measure is also enhanced by the combination of a maximum of the selected number of digits for personal entry with the unique identifiers of several aspects of the PCD mitigating against cloning of some of the elements, for example the SIM card. Under this embodiment once one element was changed the user would have to have a lengthier resigning/revalidation process to validate the change having some element of a trusted human interface before going back to the quick validation process used at every occasion of significant PCD use.

The method may also further comprise inputting further content to be sent with the message. Also the content inputting step may preferably comprise a user selection of entries into a prize draw. This then enables the security method to be used with a pay-as-you go mobile phone for example to purchase a lottery ticket or financial instrument or undertake a financial transaction in a secure manner.

The content in the body of the telecommunications message may be encrypted prior to being sent to increase security.

The authentication message may comprise a unique identifier representing the entry of the communication in a multiple-outcome event, such as a lottery or prize draw.

The method may also comprise presenting a graphical representation of the unique identifier to the user on the portable telecommunications device. This enables for example virtual tickets to be generated from the validation of a user's identity. The method may also further comprise storing the unique identifier for subsequent use. This is useful if the process is to be used repeatedly for virtual ticket purchases.

The method may further comprise setting up the verification procedure by inputting the complete personal identifier, creating a set up message containing the complete personal identifier, sending the set up message to a remote server to be stored and used for subsequent comparisons of the portion of the personal identifier.

Preferably, the method is arranged to be implemented by a downloadable application on the portable device.

According to another aspect of the invention, there is provided a security device provided on a portable telecommunication device arranged to verify the identity of the user of the portable telecommunications device, the security device comprising: presenting means for presenting, on the portable telecommunications device, a value of a predetermined variable associated with data entry of a telecommunications address, an input device arranged to receive a composite data string which comprises the telecommunications address and a portion of a personal identifier of the user, which is input into the telecommunication device, wherein the personal identifier portion is entered in accordance with the value of the predetermined variable presented to the user; an extractor for extracting the personal identifier portion from the composite data string using the value of the predetermined variable and placing the personal identifier portion in a body of a telecommunications message, and extracting the telecommunications address from the composite data string and placing this in an address field of the telecommunications message, a transmitter for transmitting the message to the telecommunications address specified in the message; a receiver for receiving an authentication of the user from a remote server if the portion of the personal user identifier sent is a valid portion of the personal identifier stored at a remote location.

According to another aspect of the invention there is provided a system for creating a virtual ticket from a fixed location using a portable user device as a ticketing terminal, the virtual ticket having a plurality of user-selected variables associated with the virtual ticket, the system comprising: a local device arranged to broadcast an identifying signal at the fixed location in a vicinity of the local device; the portable user device having a wireless communications module, the user device comprising: a receiver for receiving the identifying signal when in the vicinity of the local device at the fixed location, the portable user device being arranged to display ticketing information relating to the identifying signal on the portable user device, the ticketing information including at least some of the user-selectable variables; a user selection module arranged to enable user selection of the values of a plurality of the user-selectable variables relating to the displayed ticketing information; wherein the wireless communications module is arranged to transmit a ticketing request message including the plurality of user-selected variables to a remote server and to receive a unique identifier from the server which enables the creation of the virtual ticket on the portable user device.

Preferably the unique identifier may be arranged to be stored in a data store of the portable device for later use. This can be carried out for multiple tickets such that a group of virtual ticket identifiers are stored. This feature addresses the problem of losing unique ticket numbers as all ticket identifiers are stored and collated and can be presented for example to a second stage terminal for registration with the user's proof of ID provided if required. This arrangement is particularly useful when the unique identifiers of the tickets are to be retained for a lengthy period of time as there is no risk of losing an individual identifier as with the prior art.

To mitigate the risk of losing all of the stored identifiers if the mobile device is lost, it may be possible for the portable device to communicate the unique identifier received from a ticket to a remote data store via the communications module to make long-term storage of the unique identifiers secure and even the device independent. Also, if these unique identifiers are to be used for a further service, for example in exchange for a discount on future services or goods, then they can readily be grouped together and communicated to the service provider as they are already advantageously in the electronic domain.

The local device may comprise an interactive advertising device, having a visual display for displaying information.

The interactive device may be arranged to display tailored feedback information on its visual display to a user once interaction has commenced with the portable user device.

The local device may comprise a fixed connection to a wide area communications network and the fixed connection device is used to support communications from the portable user device to the remote server.

The local device may be arranged to transmit the identifying signal via a Bluetooth or Wi-Fi wireless network.

The portable device may comprise a smart phone or tablet computer. In this embodiment the portable device may be arranged to function as a portable virtual ticketing terminal by way of an application which has been downloaded and installed on the portable device.

The user selection module may be arranged to enable the user to select a plurality of numbers to be used as entry numbers in a prize draw or lottery.

The system may further comprise a data store for storing the unique identifier as a virtual ticket reference.

The system may further comprise generating means for generating a graphical representation of the virtual ticket on the portable device including the unique identifier.

The present invention also extends to a method of creating a virtual ticket from a fixed location using a portable device as a ticketing terminal, the virtual ticket having user-selected variables associated with it, the method comprising at the fixed location: broadcasting an identifying signal from a local device at the fixed location in a vicinity of the local device; at a portable user device: receiving the identifying signal when in the vicinity of the local device at the fixed location, displaying ticketing information relating to the identifying signal on the user device, the ticketing information including at least some of the user-selectable variables; providing means to enable selection of the value of a plurality of the user-selectable variables relating to the displayed ticketing information; transmitting a ticketing request message including the plurality of user-selected variables to a remote server; and receiving a unique identifier from the server which enables the creation of the virtual ticket on the portable device.

According to another aspect of the invention, there is provided a security device for a portable telecommunications device for verifying the identity of the user of the telecommunications device prior to sending a telecommunications message to a particular address, the security device comprising: presenting means for presenting, on the portable telecommunications device, a value of a predetermined variable associated with a stored personal identifier; enabling means for enabling a user to input a portion of the personal identifier, wherein the personal identifier portion is entered in accordance with the value of the predetermined variable presented to the user; comparing means for comparing the personal identifier portion with the stored personal identifier; and control means arranged to enable access to a communications module of the telecommunications device for sending the telecommunications message, if the comparing means show the personal identifier portion corresponds to the stored personal identifier.

### BRIEF DESCRIPTION OF DRAWINGS

FIG. 1 is a schematic block diagram of a ticket purchasing system according to an embodiment of the present invention;

FIG. 1a is a flow chart showing the operation of the ticket purchasing system of FIG. 1;

FIG. 2 is a schematic block diagram of an interactive advertising device shown in FIG. 1;

FIG. 3 is a schematic block diagram of a mobile telecommunications device shown in FIG. 1;

FIG. 4a is a schematic block diagram showing a first schema for providing a variable security address which is of fixed length but variable location, that can be used to validate an authorised user in accordance with an embodiment of the present invention;

FIG. 4b is a schematic block diagram showing a second schema for providing a variable security address which is of variable length and variable location, that can be used to validate an authorised user in accordance with another embodiment of the present invention;

FIG. 4c is a schematic block diagram showing a third schema for providing a variable security address which is of variable length but fixed location, that can be used to validate an authorised user in accordance with another embodiment of the present invention;

FIG. 4d is a schematic block diagram showing a fourth schema for providing a variable security address which is of fixed length, fixed location but variable content, that can be used to validate an authorised user in accordance with another embodiment of the present invention;

FIG. 5 is a schematic block diagram of a conventional address book for a mobile device or PCD showing six different address entries;

FIG. 5a is a schematic block diagram of an address book for a mobile device showing six different address entries operating the third schema of FIG. 4c according to an embodiment of the present invention; and

FIG. 5b is a schematic block diagram of an address book for a mobile device or PCD showing six different address entries operating the fourth schema of FIG. 4d according to an embodiment of the present invention.

### DETAILED DESCRIPTION OF EMBODIMENTS

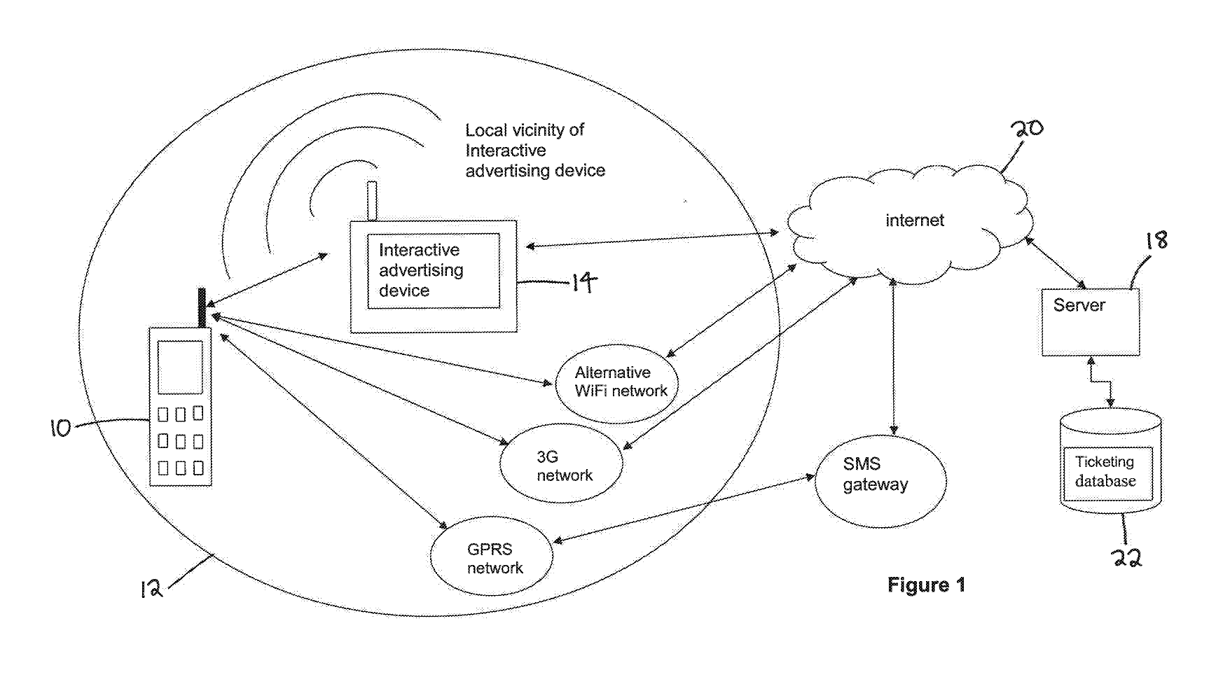

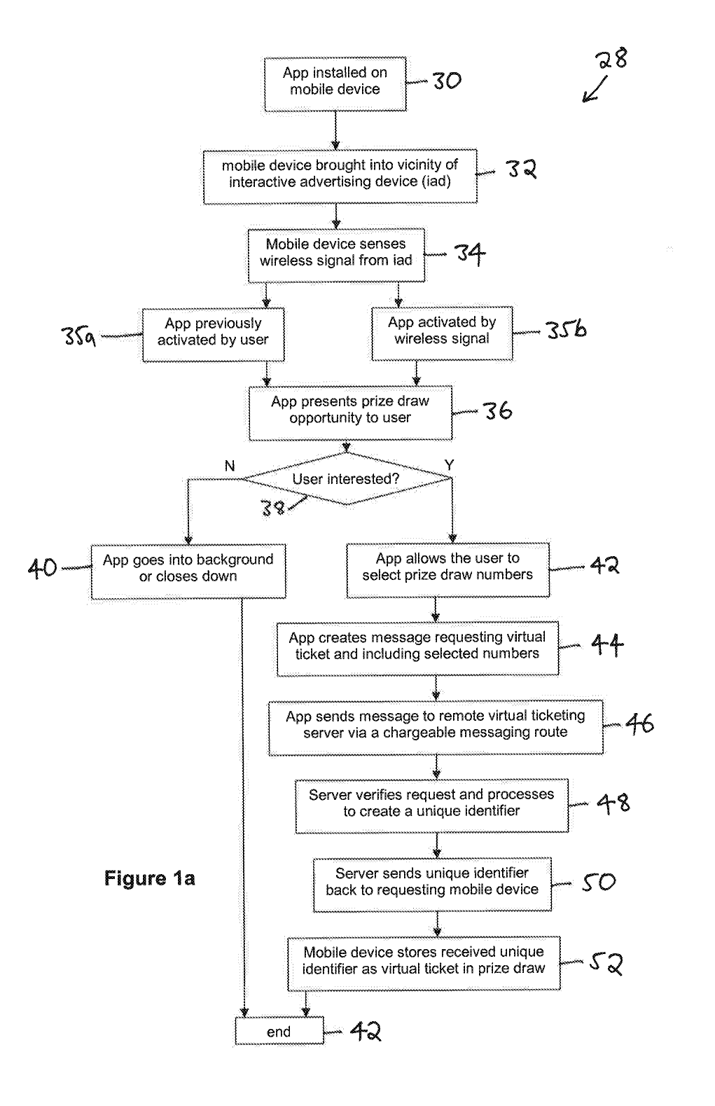

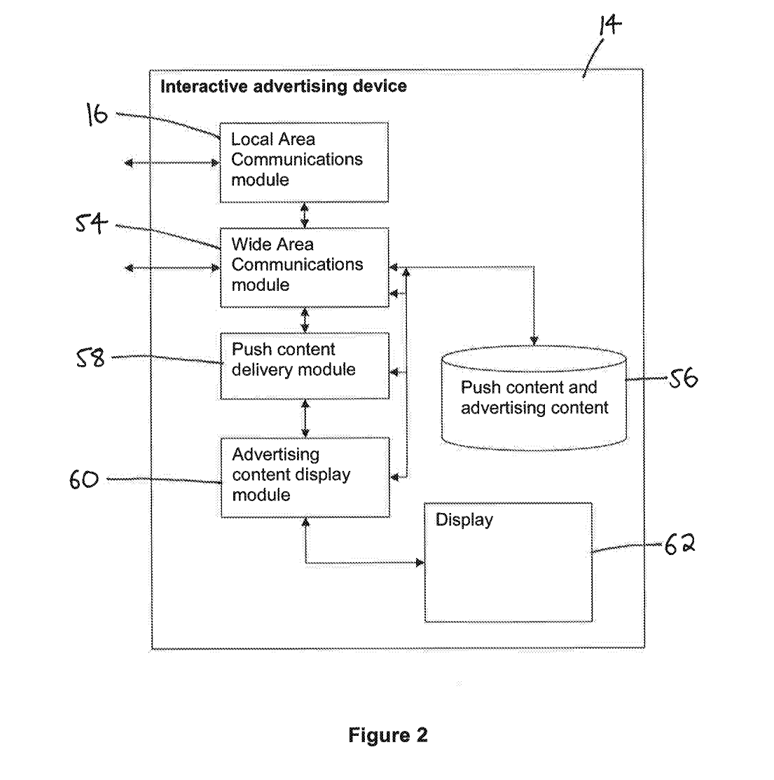

Referring to FIG. 1, there is shown a mobile telecommunications device (PCD) 10 and a shopping environment 12 including an interactive advertising device 14, such as an interactive electronic poster according to an embodiment of the present invention. The interactive advertising device 14 has a local area communications module 16 (not shown in FIG. 1, shown in FIG. 2) which enables it to communicate with the mobile device (PCD) 10 via a wireless communications medium such as Wi-Fi or Bluetooth. The interactive advertising device 14 is also connected to a remote ticketing server 18 via the internet 20 which can issue tickets for a prize incentive draw (including those associated with financial instruments and/or a promotional sale or draw) or a lottery. The remote server has its own ticketing database 22 for this purpose.

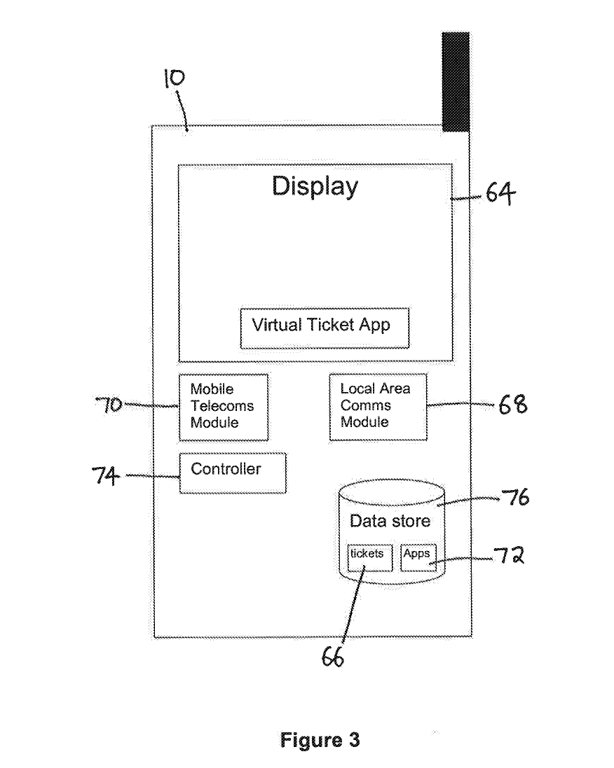

Referring to FIG. 1a a method 28 of using the ticket purchasing system of FIG. 1 is shown. The method commences with the user's mobile phone (PCD) 10 having an application (app) 72 (see FIG. 3) downloaded at Step 30 on it for ticket purchasing. This makes the mobile telecommunications device (PCD) 10, such as a smart phone or laptop, function as a virtual ticketing terminal. If this is for a lottery or prize draw use, then the app 72 may allow the user to select one or more prize draw/lottery numbers and to include these in the registration of the ticket in the ticketing database 22.

The mobile device 10 is brought at Step 32 into the vicinity of the interactive advertising device 14, and the mobile device 10 senses at Step 34 a wireless signal from the advertising device 14. If the app 72 is activated at Step 35a by the user, the app 72 runs in the background when the user is going shopping or moving about from store to store. Alternatively, the app 72 can be dormant and be activated at Step 35b by the operating system of the mobile device 10 when it receives a particular identifier via a wireless link (namely when it is moved at Step 32 into a wireless region (Wi-Fi or Bluetooth) in the local vicinity of the interactive advertising device 14).

Now that the interactive advertising device 14 has sensed at Step 34 the mobile device's 10 presence in the local area wireless region of the device 14, the electronic advertising device 14 (such as an electronic poster) then pushes at Step 36 content to the mobile device (PCD) 10 which is received via the app 72 and presented to the user on the mobile device 10. The content may typically be a message inviting the user to purchase a short/medium/long-term financial instrument with a prize incentive or it could even be a simple lottery product. Alternatively, the message may be created by the app 72 locally in response to receipt of a coded identifier from the interactive device 14 over the wireless network. Use of a coded identifier is advantageous in that it reduces the message size and thus increases the speed of communication whilst also decreasing the required bandwidth for multiple simultaneous device communications with the interactive advertising device 14.

If the user does not accept at Step 38 the proposal, the app 72 closes at Step 40 or runs in the background. The method 28 then ends at Step 42. If the user accepts at Step 38 the proposal, the app 72 enables at Step 42 the required data to be selected by the user for registration at Step 44 of the virtual ticket and its parameters (for example its prize draw numbers) and transmits at Step 46 this information to the remote server 18 via one of several routes. The first possible route is back via the Bluetooth or Wi-Fi link to the interactive advertising device 14 and then via its wide area communications module to the remote server 18. Alternatively, if an alternative Wi-Fi connection is provided for example by a third party, then this can be used to communicate the ticket entry message to the server 18. These routes are preferred as they broaden the number of different types of PCDs which can be used with the system to include Wi-Fi and Bluetooth only PCDs such as the Amazon Kindle Fire® and the Apple iPod®.

In the further alternative (for PCDs that have independent telecommunications capability), the telecommunications channels of the mobile phone could be used. For example, a message could be sent using the 3G (or other generation) wireless link to the Internet 20 and then onto the server 18, or alternatively an SMS could be sent via GPRS to an SMS Gateway and then onto the ticketing server 18 via the internet 20. A combination of such routes may be available and the mobile device 10 may select the route with the least traffic or strongest signal at the mobile device 10.

The app 72 may receive the address of the server 18 to which the communication is to be received from the user when they indicate interest in purchasing a virtual ticket to the app. The address may well be provided on the interactive advertising device 14 and manually entered by the user. Alternatively, the push message from the interactive advertising device 14 may contain the address which is then passed on to the app 72 for use should the user decide to purchase the virtual ticket. As a further alternative, the address may be pre-stored in the app 72 as one of many server/gateway addresses to which a request for a virtual ticket can be sent. In this latter case, the addresses can be stored in an address book which is controlled by the app 72 and the app 72 simply has to select the correct address of the desired server 18. Several different ticket servers 18 may be available and so this selection can be carried out using information known to the app 72 (from the push request) relating to which virtual ticket the user requires.

Once the message has been received at the server 18, it is processed at Step 48 and a unique identifier is assigned to the entry in the ticketing database 22 which is communicated at Step 50 back to the user of the mobile device 10 via the same channel as that on which the virtual ticket purchase request was received. Once the response (including the unique identifier) has been received on the mobile device 10, the unique identifier is stored at Step 52 in the data store of the mobile device 10 and acts as an electronic version of that ticket for entry into the prize draw or the lottery. The method 28 then ends at Step 42. The electronic ticket may take several forms. It can be simply a number and/or it can be a visually simulated ticket which is displayable on the user's mobile device 10.

The app 72 can also have a function to conveniently store all of the user's tickets in one place and to allow them all to be recalled on demand. This has particular benefit when carrying a second stage of registering for a further service, such as for a financial instrument associated or included with the ticket in accordance with our co-pending International patent application WO2009/019602A. This is because all of the ticket identifiers which need to be input into the system for the registration to be carried out can be transferred electronically to the registration terminal. The transfer can be automated and can occur quickly. In this way, no tickets (or their identifiers) are lost and the process of re-registration is significantly reduced. Furthermore, the results of the second stage of registration can also be stored on the mobile device 10 (or alternatively transmitted to a remote storage location such as a server 18 implementing cloud storage) as a record of the financial products or financial transactions associated with the virtual ticket identifiers. If remote storage is used, this advantageously makes the virtual tickets more secure as loss of the mobile device 10 does not mean loss of these tickets.

FIG. 2 shows the details of the interactive advertising device 14. The communications to and from the device 14 are handled by the already mentioned local area communications module 16 and the wide area network module 54. Also provided on the interactive advertising device 14 is a database 56 storing push content and advertising content. The push content is selected by a push content module 58 to be pushed to the mobile device 10. The advertising device 14 also comprises an advertising content display module 60 which selects advertising content from the database 56 and provides it to a display 62 of the advertising device 14. The advertising device 14 is interactive, by virtue of having a communications module for interaction with the mobile device 10 and by having a display 62 for presenting information to the user. For example, in response to sensing a user's interaction with content pushed to them via the local area communications module 16, the advertising device 14 can present tailored feedback to the user on its display 62. The display 62 can also be used to draw users into the vicinity of the interactive advertising device 14 so that they can be pushed content for their mobile communications device 10. Also, the interactive advertising device 14 can be adaptive to the level of interaction and the type of interaction being carried out at any one instance. This enables the advertising display 62 to change to a relevant subject matter dependent on the amount and type of local PCD interaction that is occurring. This enables the advertising to be tailored to the type or category of interaction currently occurring in the vicinity of the advertising interactive device 14.

Referring to FIG. 3, a portable telecommunications device 10 (mobile device 10) in the non-limiting form of a smart phone is shown. Here, the smart phone 10 includes a display 64 for displaying the virtual ticket 66 as well as, on some devices, acting as the data input device (for example via a touch screen). As is the case for any smart phone 10, the device 10 includes a local area communications module 68 and a standard mobile telecommunications module 70 potentially including a data communications module. Both of these and the apps 72 provided on the device 10 are controlled by the data controller 74 of the smart phone 10. The apps 72 and the tickets 66 obtained by the virtual ticket app 72 are stored in the data store 76.

In an embodiment (not shown), the app 72 is continually running in the background such that when it enters into a region of interactive advertising (being defined by the presence of a Bluetooth, Wi-Fi or other form of wireless communication signal) it transmits its ID details and receives the advertising promotion data. This data notifies the PCD that a product is available at a discount. The user can read the advertising data and respond in a predefined manner. One such way of responding is to signal that the material has been absorbed via a method described in co-pending UK patent application nos. GB1302389.0 and GB1222639.5. Responding in the correct manner can provide the user with an entry into a prize draw or some form of product discount.

There are two ways in which a mobile device 10 is managed—pay monthly (so called post-pay) or pay-as-you-go (prepay). For post-pay, the user is registered and has a central account (typically in a customer relations database) with the network service provider. For this user, it is easy to implement the invention of WO2009/019602A as a registered user assuming of course that the network service provider is either providing the prize incentive draw or lottery or allowing access of a third party, who is providing this service, to its customer relations database. This can be affected by the app 72 notifying the user of an opportunity to enter into a prize draw as in WO2009/019602A or a lottery, for example as has been described above. If the user wishes to participate, they indicate their desire to play by interacting with the options provided by the app 72 and subsequently they use the mobile device 10 to select their lottery or prize draw numbers. The selection can also be random if this option is selected by the user. Then the app 72 creates an SMS message and sends this to a premium pay short code where the user's account can be charged a premium amount (say GBP 1.20).

The SMS message contains the user's unique ID (the IMSI of the mobile device 10), the ID of the store at which the lottery game opportunity was pushed to the mobile device 10 and the selected lottery numbers. The mobile device 10 of the user receives back from the server 18 a unique identifier which forms the virtual ticket 66 for entry into the lottery or prize draw in another return SMS message. The virtual ticket also compromises a coded key for access to promotional items in the store, the presentation of the code key in a purchase process with the stored systems allows for the promotional items to be discounted or the discount rendered to the purchaser.

As the user's details are already provided at the network service provider's account, there is no need for a second stage registration process following the virtual ticket purchase. All the “know your client” (KYC) checks and the second stage of the registration can be carried out without involving further interaction by the user.

The mobile phone app 72 then stores the lottery details as well as the user entries and notifies the user if they have won, once the lottery or prize draw has taken place. The results, in this case, are sent in an SMS message to each mobile device (PCD) 10 for comparison with the stored virtual ticket numbers on that device 10. The app 72 can even be configured to match the winning numbers and the user's selected draw numbers to determine if the user has won. If so the app 72 can indicate this to the user by way of an alert generated by the mobile device 10.

Whilst the use of an SMS message has been described above, other types of messages and other communications channels can also be used. For example, an e-mail can be sent via a 3G (or other generation) channel or via the Wi-Fi or Bluetooth channels to the server 18. Communication back to the mobile device 10 would also be via the same type of message and channel. Various other systems could be used to effect a payment for this service and this is not the subject of this patent application.

For devices 10 registered under the pay-as-you go (prepay) scheme, the user may well be anonymous to the service provider and so it is not possible to identify the user in order to complete the KYC checks necessary for registration of the user for providing a financial service for example. This is also the case in the post-pay scheme described above if the service provider is unwilling to allow access to their customer relations database to provide user details to the third party. In both these cases, a different aspect of the present invention can be used as is described in the embodiments below.

In order to meeting the government imposed KYC (Know Your Client) requirements (to combat money laundering), it is necessary to carry out a minimal security registration. This minimal security registration stores only enough information to affect the security check but not enough to form a useable record for other applications. The key is to request some personal identification information form the user, for example the date of birth of the user as is used in the current embodiment. However, in an alternative embodiment, the user's surname or selected initials from one or more of either of the first names or the surnames of the user can be provided as the security information. In the case of the initials of names being used it can be referred to by position such that the user is requested to supply the first or last initial of the first name or the second name and/or the surname. It can be that the user is simply asked to provide the first or last initials of his various names, i.e. his first middle or last name and chooses for himself which names he applies this to. Thus even if the user's names are known to a third party, this third party will not know which name and which initial was picked. In this incarnation the user can literally pick the initial and apply a numeral to that initial designating where in the name the initial occurs. Thus in the name Ralph Omar, it would be possible to designate the letter ‘a’ and the numeral ‘2’ and the letter ‘M’ and the numeral ‘2’. Any third party would not know what letters had been chosen by the user or their position in the user's name even if the third party knew the user's name. These are pieces of information which will not be forgotten by the user unlike a password or a chosen identification number. Also by providing only one of these pieces of information, this does not present enough information to carry out any useful further actions which may cause concern for users who wish to remain anonymous. This piece of security information is stored at the central server and used to authenticate subsequent communications from the user.

The minimal registration procedure is required in the two situations outlined above, namely when the user is anonymous (prepay) or their details cannot be accessed by a third party. Whilst registration is not required for post-pay users whose details are accessible to third parties, in all three categories of situations, the present embodiment of requiring can be used.

However, the present embodiment can also be used in the case when the post-pay user's details are available to the third party, but a higher degree of security is required. This is typically useful to ensure that the person making the request on the mobile device 10 is who they claim to be (namely the owner).

The following description relates to the security aspect of the present invention which can be used to identify a user of the mobile device (PCD) 10 regardless of whether the user is a prepay or a post-pay customer. It is assumed that the user has provided their date of birth (or surname in the alternative embodiment) in the minimal registration procedure described above and that this security information is stored at the central server 18, or alternatively that a registration procedure is not required because this security information is available to third parties for post-pay customers.

The security feature requires the user to use some of this stored security information (personal identifier) within an address used for a communication with the server 18. The security information is never the complete variable (date of birth) but only a known subset (portion) of it which can be checked against the complete security information stored at the server 18. The way in which this can be accommodated is that the position/size/length of the subset of security information which is to be put into the address is known to the app 72. The app 72, in fact, specifies this to the user on the mobile device 10 before the user inputs the address to which the communication is to be sent. The app 72 can therefore use this to strip out the subset of security information from an entered address and append the stripped out security information to the body of the message rather than distorting the message address. It is even possible for the location and the size of the subset of security information that is entered with the address in a composite data string to be known, with the security coming from the variable content of the subset of security information which is entered.

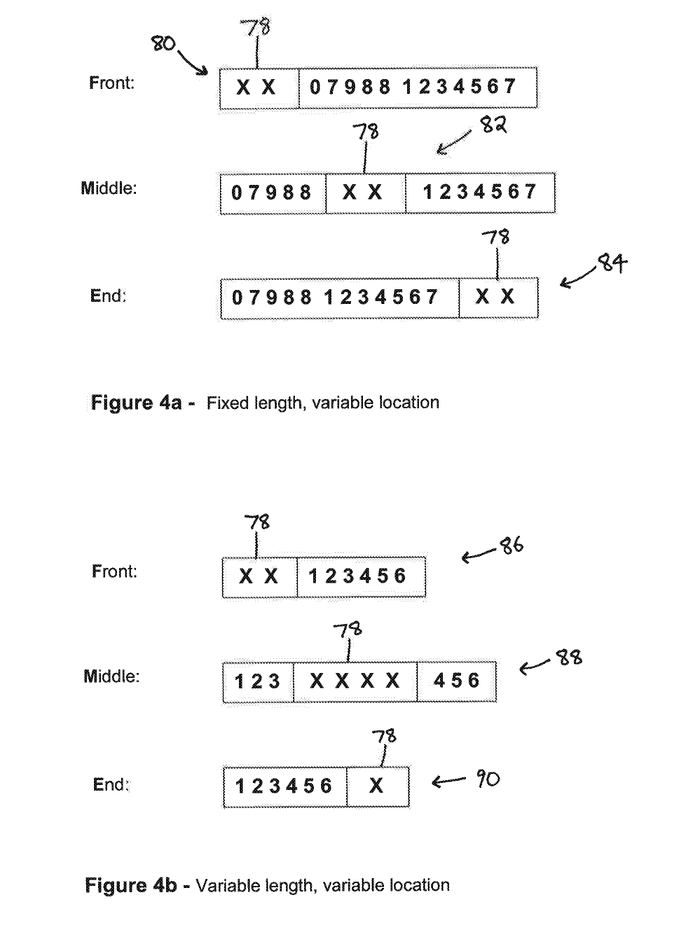

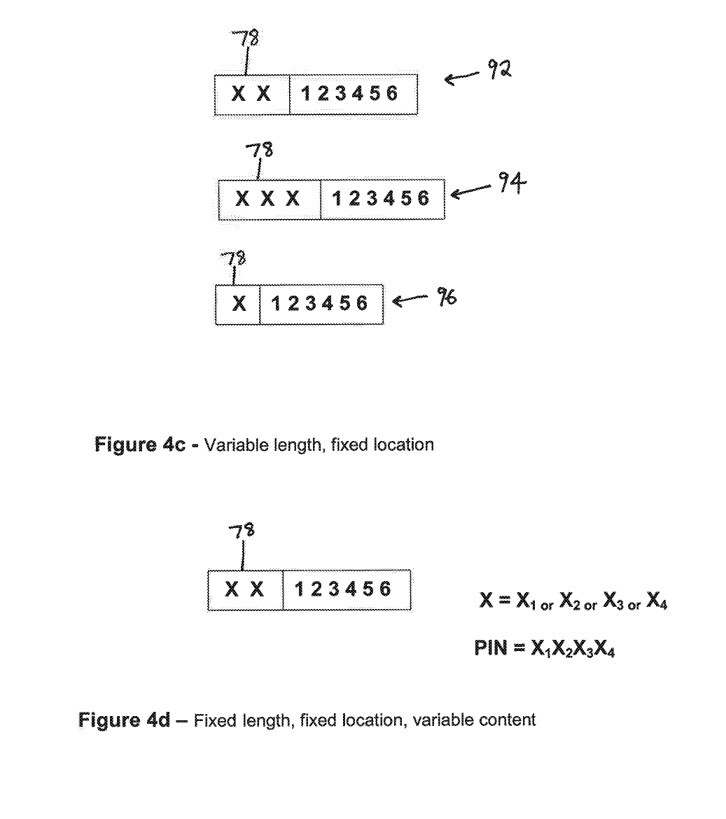

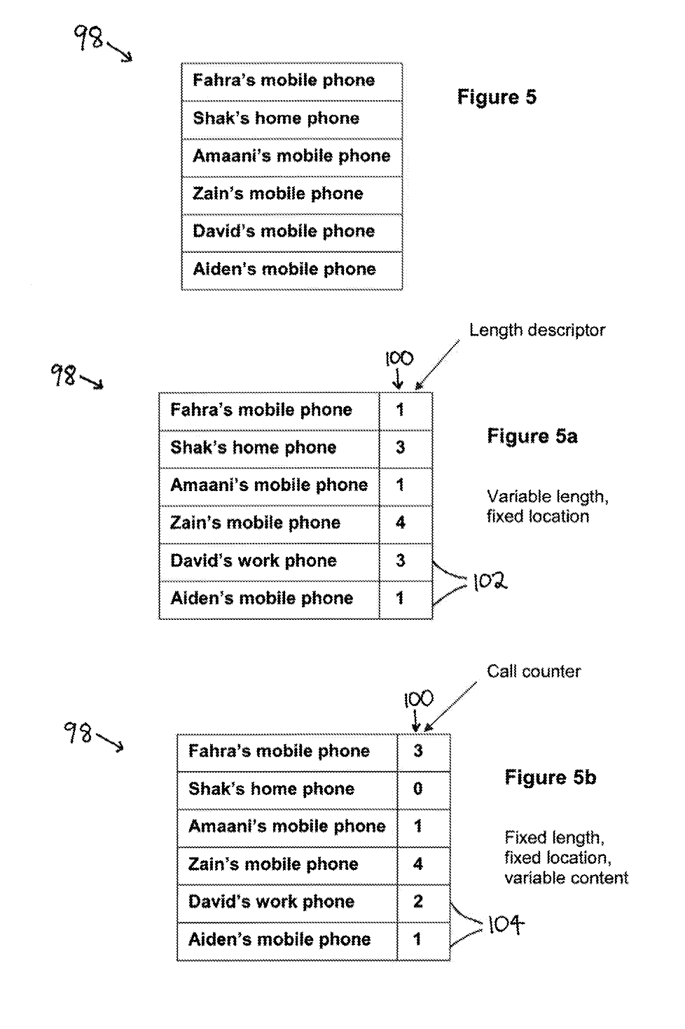

The key advantage of providing this subset of security information each time the portable device (PCD) 10 is used to effect a communication, for example for a virtual ticket 66, is that the user has to provide some security information. Also, this security information changes each time the user sends a communication such that it is not possible to compromise the security information by simple observation. In the following described embodiments, the user's date of birth is used as is described below with reference to FIGS. 4a to 5b.

The following describes four different security schemes which can be used to implement the present invention. However, it is to be appreciated that other combinations of variable position, variable location, variable size and variable content can be used as desired to create the required level of security in the schema and the embodiments described herein are only exemplary combinations.

FIG. 4a shows schematic diagram of a fixed-length subset of the security information, which is to be provided at a variable location 78. Three locations for the subset of security information are specified, namely front (F) 80, middle (M) 82 or end (E) 84 of the contact address to be entered. The length of the subset is always 2 bits of the security information. When the user wishes to send a communication, the mobile device (PCD) 10 informs him or her of the location that the security information is to be provided at. Then the user simply enters the contact address (telephone number in this embodiment) and depending on the position locator indicated to the user by the app, the user inserts two digits of their date of birth at the correct location. In this embodiment, any two numbers of the user's date of birth may be added. However in alternative more secure embodiments, there may be restrictions applied as to which two numbers of the date of birth need to be added. For example, in these alternative embodiments, the specific numbers can vary depending on how many times the security procedure has been accessed. So for the first time of use, the first two digits of the date of birth can be entered. The second time of use, the second two digits of the date of birth can be entered and the third time the last two digits or the date of birth can be entered. On the fourth use, the first two digits are required as the requirement re-circulates with a modulo-2 functionality. However, in this embodiment, any two sequential digits of the date of birth are acceptable, which makes it easier for the user but slightly decreases the level of security.

Once the contact address and the two digits of the security information have been entered, the app 72 removes the security information from the address using its knowledge of the location of the security information and uses the remaining contact address to notify the communications module of the number to be dialled. The removed security information is appended to any message to be sent to the contact address. The communication will also include the unique identifier (IMSI in this embodiment) of the PCD 10. At the server 18, the security information is crosschecked against the stored date of birth for this PCD 10 using the unique identifier of the device 10 to validate the user as has been described above. Clearly, fraudulent use of the mobile device 10 will result in incorrect information having been entered at the security information locations which when checked at the remote server 18, will result in a rejection of the virtual ticket purchase request.

FIG. 4b shows an alternative security schema. Here the security information to be input also has a variable location 78, but also has a variable length. This schema works in exactly the same way as has been described above in relation to FIG. 4a, with the exception that the number of digits of security information to be added is not fixed but rather is variable. The app 72 thus not only notifies the user of the location of the security digits to be input, but also the number of digits. Thus in the examples shown in FIG. 4b, the first example 86 would specify ‘Front 2’ (F2), the next example 88 would state ‘Middle 4’ (M4) and the last 90 would specify ‘End 1’ (E1). This schema provides an enhanced level of security as there is greater variation in the type of security information added to the contact address.

The security information which is placed into the message body by the app can be encrypted to improve security before being sent and decrypted at the server 18. Various schemes exist for encryption of the security information at the mobile device 10 and decryption at the server 18 and these are not described in detail in this application as they will be part of the skilled addressee's knowledge.

FIG. 4c shows another alternative security schema. Here, the security information to be input also has a variable length but this time it has a fixed location 78. This schema works in exactly the same way as has been described above in relation to FIG. 4b, with the exception that the location of the security information input into the contact address is fixed. The app 72 thus only notifies the user (via the mobile device screen 64 or speaker) of the number of digits to be input, as the user knows of the position location. Thus in the examples shown in FIG. 4c, the first example 92 would specify ‘2’, the next example 94 would state ‘3’ and the last 96 would specify ‘1’. This schema is an easy to remember schema for the user.

FIG. 4d shows another alternative security schema. Here, the security information to be input has a fixed length and a fixed location 78. However, the content of the security information is variable. This schema works in exactly the same way as has been described above in relation to FIG. 4a, with the exception that the location of the security information input into the contact address is fixed. The app 72 thus only prompts the user in relation to the variable nature of the subset of the security information to be input. For example, the app 72 may specify the digit locations of the required security content, for example by asking for the first and last digits of the security information or the middle two numbers of the security information. Thus, in the example shown in FIG. 4d, the user inputs two digits at the front of the contact address to a specified subset of the security information. Many different ways of selecting the subset of security information are possible and only a few have been described above (namely the modulo-2 example set out as an alternative schema in relation to FIG. 4a and the digit location specification mentioned above in relation to FIG. 4d).

The above-described schemes work well for contact addresses when they are input by the user at the time of accessing the service provided by the server 18 (typically a lottery or prize incentive bond). However, when the user of the portable device 10 wishes to use a contact address which is stored in his address book for example, or which is stored in the address book of the app, then a slightly different approach is used which is described below.

In FIG. 5, a prior art user's address book 98 is shown. Here, the identifiers of the addresses are provided in a list and an address (associated with the identifier) can be selected for enabling a communication to that address. FIGS. 5a and 5b are directed to embodiments of the present invention which have a modified address book 98. As can be seen in these figures, the address book 98 has an additional column 100 which provides information to the user as to what security information is required in order to facilitate a valid communication with the address. FIGS. 5a and 5b correspond to FIGS. 4c and 4d in terms of the schema used for the input of security information.

More specifically, referring to FIG. 5a, the additional column 100 is populated with a length descriptor 102 for each identifier of an address. The column 100 is populated by numbers which signify the length of the security information to be input by the user. The issue of position of input is not applicable as the addresses are already stored within the mobile device data store.

Thus using the schema shown in FIG. 5a, the user selects an address identifier from his mobile device 10 and then inputs the required number of digits of the security information which has been specified. The app 72 will then take this security information and place it within the body of the message to be sent. The security information can be checked at the server 18 for a valid user identification to purchase a virtual ticket 66. However in an alternative use, the security information can be compared with security information which has been pre-stored on the mobile device 10 by use of the app. In this case, the registration procedure is simply carried out on installation of the app 72 and provides a way of ensuring that each communication from the device 10 to an address in the address book 98 requires the correct security code to be input. Clearly, the input of the security information onto the mobile device 10 for example can present a security risk. However, the security information can be encrypted by a suitable 128-bit encryption algorithm when stored on the device, such that this risk is somewhat mitigated.

Referring to FIG. 5b, an alternative schema for providing security to use of addresses in the PCD's address book 98 is shown. The additional column 100 is populated with a call counter number 104. This call counter number simply keeps track of the number of times this address has been communicated to by the PCD 10. The call counter number 104 also signifies to the user which part of the security information is to be input. Essentially this schema works in the same manner as that described above in relation to FIG. 4d. The user knows that the call counter number specifies the precise digits of the security information which are to be input. Typically, this can be a modulo number so that for example for a six-digit security number, a modulo-6 regime can be applied to the call count to signify the starting position of the two-digit number which is to be input. In this regard, the app 72 will not only take the two digits of variable content and put them in the body of the message being sent, but also it adds the call counter number 104 so that in the case of a remote validation the remote server 18 can determine which part of the security information to compare the provided content with. Typically this message body content would be encrypted.

Alternatively, if the security check is carried out locally on the PCD 10 (not for a remote virtual ticketing solution), then there is no need for the communication message to have the security information or call counter number added to the body of the message. This is because the security check is carried out locally at the PCD 10 before sending the message.

1-28. (canceled)

29. A system for creating a virtual ticket from a fixed location using a portable user device as a ticketing terminal, the virtual ticket having a plurality of user-selected variables associated with the virtual ticket, the system comprising:
a local device arranged to broadcast an identifying signal at the fixed location in a vicinity of the local device;
the portable user device having a wireless communications module, the portable user device comprising:
a receiver for receiving the identifying signal when in the vicinity of the local device at the fixed location, the portable user device being arranged to display ticketing information relating to the identifying signal on the portable user device, the ticketing information including at least some of the user-selectable variables;
a user selection module arranged to enable the user to select the values of the plurality of the user-selectable variables relating to the displayed ticketing information;
wherein the wireless communications module is arranged to transmit a ticketing request message including the plurality of user-selected variables to a remote server and to receive a unique identifier from the server which enables the creation of the virtual ticket on the portable user device.

30. A system according to claim 29, wherein the local device comprises an interactive advertising device, having a visual display for displaying information.

31. A system according to claim 29, wherein the interactive device is arranged to display tailored feedback information on its visual display to a user once interaction has commenced with the portable user device.

32. A system according to claim 29, wherein the local device comprises a fixed connection to a wide area communications network and the fixed connection device is used to support communications from the portable device to the remote server.

33. A system according to claim 29, wherein the local device is arranged to transmit the identifying signal via a Bluetooth or Wi-Fi wireless network.

34. A system according to claim 29, wherein the portable device comprises a smart phone or tablet computer.

35. A system according to claim 34, wherein the portable device is arranged to function as a portable virtual ticketing terminal by way of an application which has been downloaded and installed on the portable device.

36. A system according to claim 29, wherein the user selection module is arranged to enable the user to select a plurality of numbers to be used as entry numbers in a prize draw or lottery.

37. A system according to claim 29, further comprising a data store for storing the unique identifier as a virtual ticket reference.

38. A system according to claim 29, further comprising a generating module for generating a graphical representation of the virtual ticket on the portable device including the unique identifier.

39. A method of creating a virtual ticket from a fixed location using a portable user device as a ticketing terminal, the virtual ticket having user-selected variables associated with the virtual ticket, the method comprising at the fixed location:
broadcasting an identifying signal from a local device at the fixed location in a vicinity of the local device;
at a portable user device:
receiving the identifying signal when in the vicinity of the local device at the fixed location,
displaying ticketing information relating to the identifying signal on the portable user device, the ticketing information including at least some of the user-selectable variables;
providing a user-selection module arranged to enable user selection of the values of a plurality of the user-selectable variables relating to the displayed ticketing information;
transmitting a ticketing request message including the plurality of user-selected variables to a remote server; and
receiving a unique identifier from the remote server which enables the creation of the virtual ticket on the portable user device.

40. A system according to claim 29, wherein the receiver of the portable user device is arranged to automatically sense the presence of the identifying signal when in the vicinity of the local device at the fixed location and consequently to display the ticketing information relating to the identifying signal on the user device.

41. A system according to claim 35, wherein the receiver of the portable user device is arranged to automatically sense the presence of the identifying signal when in the vicinity of the local device at the fixed location and consequently to activate the application on the user device.

42. A system according to claim 35, wherein the receiver of the portable user device is arranged to be controlled by the application to automatically sense the presence of the identifying signal when in the vicinity of the local device at the fixed location and consequently to display the ticketing information relating to the identifying signal on the user device.

43. A system according to claim 31, wherein interactive display device is arranged to change the displayed information to more relevant information dependent on the amount and type of interaction that is occurring locally between the interactive display device and the portable user device.

44. A system according to claim 43, wherein the displayed information is advertising information and the interactive display device is arranged to tailor the advertising to the type or category of local interaction currently occurring between the interactive display device and the portable user device.
